(19) United States
(12) Patent Application Publication
(10) Pub. No.: US 2005/0008733 A1
(43) Pub. Date: Jan. 13, 2005

(54) Method for making fermented food and fermented food made thereby having suppressive effect against helicobactor-pylori and food-poisoning bacillus

(76) Inventors: Hee-kyong Bae, Gyeonggi-do (KR); Jong-wook Son, Seoul (KR); Jin-hee Lee, Seoul (KR); Jae-kag Lim, Seoul (KR)

Correspondence Address: SWANSON & BRATSCHUN L.L.C., 1745 SHEA CENTER DRIVE, SUITE 330, HIGHLANDS RANCH, CO, 80129, US

(21) Appl. No.: 10/496,603

(22) PCT Filed: Dec. 20, 2002
(86) PCT No.: PCT/KR02/02394

(30) Foreign Application Priority Data
Dec. 19, 2001 (KR) 20010081350

(51) Int. Cl. A23K 1/00

(52) U.S. Cl. 426/52

(57) ABSTRACT

The present invention related to a method for preparing fermented food having suppressive effect against Helicobactor-pylori and food-poisoning bacillus that comprises the steps of inoculating lactic ferments into the food, wherein said lactic ferments is selected from the group consisting of Lactobacillus genus, Bifidobacterium genus, Streptococus genus and the mixture thereof, and said food is selected from the group consisting of grain, fruit, vegetables and their mixture; and incubating said inoculated mixture at 15-35° C. for 12˜48 hours.

### TECHNICAL FIELD

The present invention related to a method for making fermented food and fermented food made thereby having suppressive effect against Helicobactor-pylori and food-poisoning bacillus. More particularly, the present invention related to a fermented food having suppressive effect against helicobactor-pyloriy, food-poisoning bacillus and intestinal harmful bacillus by inoculating lactic ferments selected from the group consisting of Lactobacillus genus, Bifidobacterium genus, Streptococus genus and their mixture into the food.

### BACKGROUND

Helicobactor-pylori , a spirillum living upon gastric mucous membrane, cause various gastroenteric troubles on upper stomach, and it were depends on sensitivity of infected person and types of bacillus. According to current researches, it have been deduced that the main infection pathway of bacillus from stool is through his mouth. And the infection rate is up to 70˜80% in adult person and increase in proportion to one's age in Korea.

Also, helicobactor-pylori present 90˜95% of duodenal ulcer and 60˜80% of stomach ulcer, and the relapse of ulcer is dramatically decreased by eradicating helicobactor-pylori from the portion. Therefore eradicating helicobactor-pylori is needed for clinical therapy.

In Korean Patent Publication No.2000-49499, a food having suppressive effect against helicobactor-pylori was disclosed. But the food disclosed in the patent was for a beverage containing lactic ferments. So it is necessary to develop various food having suppressive effect against helicobactor-pylori including grain, fruit and vegetables as well as beverage.

In addition, safety of food is required more and more by increasing dining-out. Accident related to food can incur with patty careless, and especially for food-poisoning bacillus, food poisoning incur easily in the absence of sanitary facilities in dining room.

In 1997, there was no large-scale food-poisoning patient exceeding 300 patents. However, food-poisoning is on the increase. In school-feeding facilities, there were 675 patients from 2 accidents, 1,752 patients from 3 patients and 2,669 patients from 5 accidents in 1998, 1999 and 2000 respectively.

Among the accidents of food poisoning caused in 2000, food poisoning caused by salmonella bacillus was 30 of 104 accidents (28.8%) and 2,591 of 7,269 patients (35.6%), and it was the main cause of accident as well as patient.

According to the report of Korea Food and Drug Administration of January, 2001, different from other infectious disease, this food poisoning is incurred when a food contaminated with food-poisoning bacillus over 100 million is taken through one's mouth.

Food-poisoning bacillus and intestinal harmful bacillus also live upon one's intestines in natural condition. And the susceptibility of incidence is depends on the amount of bacillus taken from exterior circumstance. Especially, salmonella and E.coli O-157 bacillus, a high-risk pathogen, can cause food poisoning even in small amounts.

If a bacillus having suppressive effect against the food-poisoning bacillus were attached on the intestines, it may help to eradicate the harmful bacillus, and to maintain good condition of the intestines.

As described above, food having suppressive effect against the food-poisoning bacillus has been needed not only for beverage but also for various foods.

### DISCLOUSURE OF INVENTION

The present invention has been studied in this field in order to overcome the foregoing and other disadvantages in the prior art described above.

The object of the present invention is to provide a method for making fermented food and fermented food such as grain, fruit and vegetables made thereby, having suppressive effect against Helicobactor-pylori, food-poisoning bacillus and intestinal harmfulbacillus.

To accomplish the object of the present invention, a fermented food having suppressive effect against Helicobactor-pylori and food-poisoning bacillus is prepared by inoculating lactic ferments into the food, wherein said lactic ferments is selected from the group consisting of Lactobacillus genus, Bifidoacterium genus, Streptococus genus and the mixture thereof, and said food is selected from the group consisting of grain, fruit, vegetables and their mixture; and incubating said inoculated mixture at 15˜35° C. for 12˜48 hours.

### BRIEF DESCRIPTION OF DRAWINGS

FIG. 1 is depicted a graph showing an analyzed organic acid for characterizing the fermented food of the present invention.

FIG. 2 is depicted an inhibition zone for analyzing the helicobactor-pylori inhibition effects of the fermented food of the present invention.

FIG. 3a is depicted an inhibition zone for analyzing the salmonella bacillus inhibition effects of the fermented food of the present invention.

FIG. 3b is depicted an inhibition zone for analyzing the Listeria bacillus inhibition effects of the fermented food of the present invention.

FIG. 3c is depicted an inhibition zone for analyzing the O-157 E.coli inhibition effects of the fermented food of the present invention.

FIG. 3d is depicted an inhibition zone for analyzing the Aeromonas bacillus inhibition effects of the fermented food of the present invention.

### BEST MODE FOR CARYING OUT THE INVENTION

The detailed description of the present invention is as follows.

In the present invention, a lactic ferments having suppressive effect against helicobactor-pyloriy, food-poisoning bacillus and intestinal harmful bacillus is selected from the group consisting of Lactobacillus genus, Bifidobacterium genus, Streptococus genus and their mixture.

Preferably, it can be Lactobacillus fermentum, Lactobacillus confusus, Bifidobacterium infantis and Streptococus fecalis.

Practical and presently preferred embodiments of the present invention are described as shown in the following Examples, and not to be constructed as limiting the present invention.

### EXAMPLE 1

Fermented food was prepared according to the conventional method by inoculating Lactobacillus fermentum into the mixture of brown-rice, black-bean and kale, pH 4.5, and followed by incubating it for 24 hours at 20° C.

### EXAMPLE 2

Fermented food was prepared according to the same method of Example 1 except substituting Lactobacillus confusus for Lactobacillus fermentum.

### EXAMPLE 3

Fermented food was prepared according to the same method of Example 1 except substituting Bifidobacterium infantis for Lactobacillus fermentum.

### EXAMPLE 4

Fermented food was prepared according to the same method of Example 1 except substituting Streptococus fecalis for Lactobacillus fermentum.

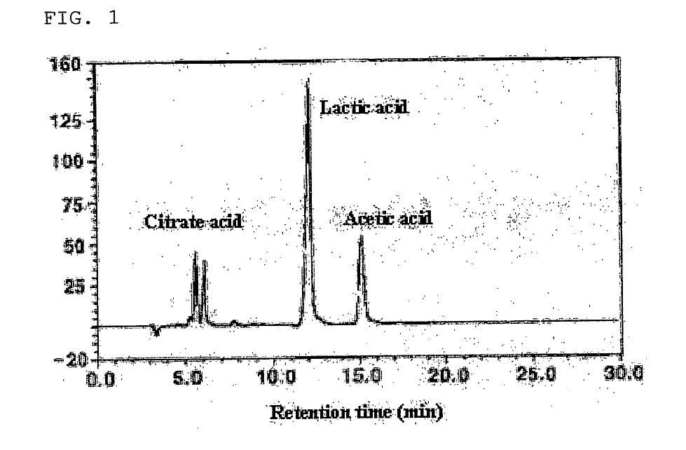

The result of organic acid analysis for characterizing the fermented food by lactic ferment was illustrated in table 1 and FIG. 1.

TABLE 1

| | Ret. Time | Peak before | Peak after |
|---|---|---|---|
| | (min) | fermentation | fermentation |
| Citric acid | 5.550 | 0.070 | 16.454 |
| Lactic acid | 6.060 | 0.146 | 54.915 |
| Acetic acid | 6.667 | 0.366 | 26.843 |

As shown in table 1 and FIG. 1, citric acid, lactic acid and acetic acid were produced by fermentation. Especially, lactic acid was more produced than others.

### EXPERIMENTAL EXAMPLE 1

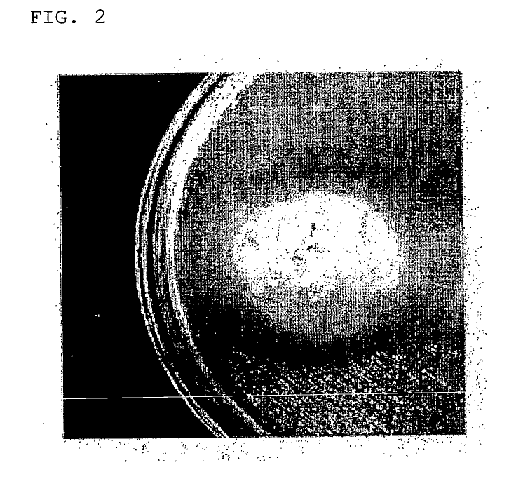

The result of suppressive effect of example 1 against Helicobactor-pylori was illustrated in table 2, and each inhibition zone was depicted in FIG. 2.

After spreading Helicobactor-pylori onto solid media, which has a hole that was punched with pasteurized pipet, and the fermented food was placed onto the hole then cultivated it in CO₂ incubator.

The suppressive effect against Helicobactor-pylori was identified on measuring the diameter of the inhibition zone.

TABLE 2

| | Diameter of inhibition zone |
|---|---|
| | (unit: mm) |
| Example 2 | 10 |
| Example 3 | 11 |
| Example 4 | 11 |

As shown in table 2, from the distinctly separated inhibition zone layer, the examples were determined that it has excellent suppressive effect against Helicobactor-pylori.

### EXPERIMENTAL EXAMPLE 2

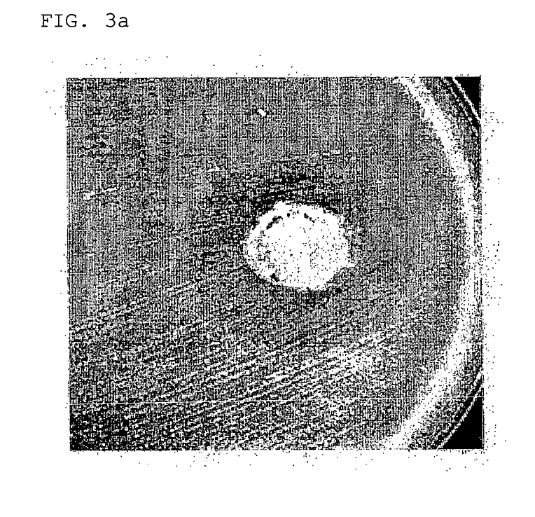

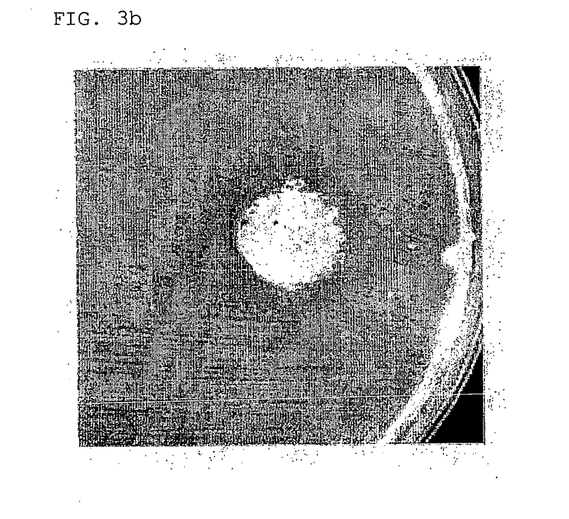

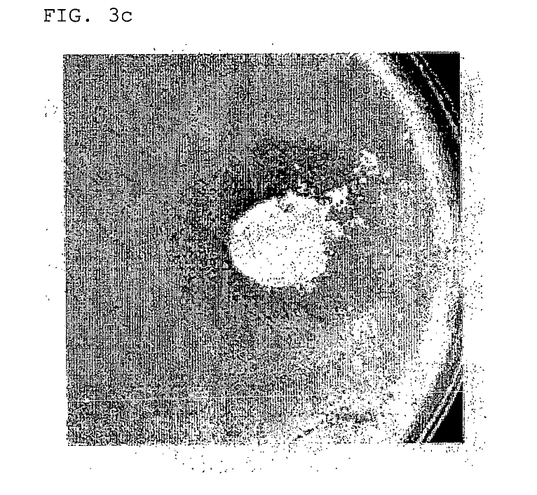

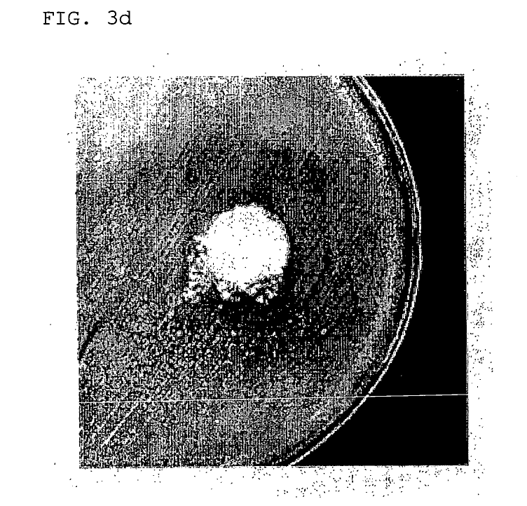

The result of suppressive effect analysis of example 2, 3 and 4 against food poisoning bacillus were illustrated in table 3, and each inhibition zones of Salmonella bacillus, Listeria bacillus, O-157 E-coli and Aeromonas bacillus were depicted in FIG. 3a, 3b, 3c and 3d respectively.

After mixing Lactic ferment culture medium with the same volume of BHI(Brain Heart Infusion, 2X), food poisoning bacillus of Salmonella genus, E. coli O-157, Aeromonas genus and Listeria genus were diluted to 1% final concentration then incubated for 24 hours.

After then, suppressive effects against food-poisoning bacillus was identified by measuring the inhibition zone as described in Example 1.

TABLE 3

Diameter of Inhibition Zone (mm)

| | Salmonella | Listeria | E.coli | Aeromonas |
|---|---|---|---|---|
| | bacillus | bacillus | o-157 | bacillus |
| Example 2 | 12 | 8 | 7 | 7 |
| Example 3 | 10 | 7 | 6 | 8 |
| Example 4 | 10 | 8 | 7 | 7 |

As shown in FIG. 3a, 3b, 3c, 3d and table 3, the Examples in the present invention have strong suppressive effects against food-poisoning bacillus when the distinct inhibition zone was considered.

### INDUSTRIAL APPLICABILITY

As described above, the fermented food having suppressive effect against helicobactor-pyloriy and food poisoning bacillus give efficient suppression against helicobactor-pyloriy and food poisoning bacillus in extended food area when it is compared with fermented milk products, and the fermented food of grain, fruit and vegetables suppress helicobactor-pyloriy and food poisoning bacillus effectively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for preparing fermented food having suppressive effect against Helicobactor-pylori and food-poisoning bacillus that comprises the steps of
inoculating lactic ferments into the food, wherein said lactic ferments is selected from the group consisting of Bifidobacterium genus, Streptococus genus and the mixture thereof, and said food is selected from the group consisting of grain, fruit, vegetables and their mixture; and
incubating said inoculated mixture at 15˜35° C. for 12 hours to less than 48 hours.

2. A fermented food made of grain, fruit, vegetables and the mixture thereof, which is prepared by said method described in claim 1.
